(19) United States
(12) Patent Application Publication
(10) Pub. No.: US 2014/0040796 A1
(43) Pub. Date: Feb. 6, 2014

(54) INTERACTING WITH GRAPHICAL WORK AREAS

(71) Applicants: Joseph Tighe, Chapel Hill, NC (US); Anmol Dhawan, Ghaziabad (IN); Richard Coencas, San Jose, CA (US); Gregg D. Wilensky, San Francisco, CA (US)

(72) Inventors: Joseph Tighe, Chapel Hill, NC (US); Anmol Dhawan, Ghaziabad (IN); Richard Coencas, San Jose, CA (US); Gregg D. Wilensky, San Francisco, CA (US)

(21) Appl. No.: 12/351,706

(22) Filed: Jan. 9, 2009

(51) Int. Cl. G06F 3/048

(52) U.S. Cl. 715/765

(57) ABSTRACT

Among other disclosures, a method may include receiving a repositioning request, relative to a work area marker, and an adjustment request, relative to a work area, wherein the work area is associated with a portion of graphical data, and the marker allows interaction with the work area. The method may include deriving an updated marker and an updated work area, wherein the updated marker reflects the repositioning request, the updated work area is associated with the portion, and the work area reflects the adjustment request. The method may include providing visually the updated marker, wherein the updated marker allows interaction with the updated work area.

### BACKGROUND

The present disclosure relates to accessing graphical work areas.

Performing activities (e.g., adjustments, modifications, editing, etc.) related to graphical data is facilitated by editing tools. Editing graphical data can involve a two-step process. First, a user indicates the part of the graphical data to modify. Second, the user applies an image adjustment to the indicated area. The area the user modifies, can be, e.g., a selection, layer or combination of the two. A selection can refer to a portion of original graphical data, e.g., distinguished visually as a marquee selection (i.e., dotted or dashed line that borders the selection and can be animated—“marching ants”). A layer can be a copy of the original graphical data enabling the adjustment to be made without modification of the original data. Image editing applications, such as ADOBE® PHOTOSHOP® ELEMENTS, developed by Adobe Systems Incorporated of San Jose, Calif., can provide a list of layers from which a user can choose. When a user chooses a layer, graphical operations can modify graphical data on that layer without altering data on the other layers. Layers can be ordered such that a layer that is on top of another, obscures, or partially obscures, a lower layer.

### SUMMARY

In general, in one aspect, embodiments of the invention feature a method, implemented by a computer configured to provide graphical work areas. The method includes receiving a repositioning request, relative to a work area marker, and an adjustment request, relative to a work area, where the work area is associated with a portion of graphical data, and the marker allows interaction with the work area. The method further includes deriving an updated marker and an updated work area, where the updated marker reflects the repositioning request, the updated work area is associated with the portion, and the work area reflects the adjustment request. The method further includes providing visually the updated marker, wherein the updated marker allows interaction with the updated work area.

These and other embodiments can optionally include one or more of the following features. The portion can be a first portion. The work area marker can be a first work area marker. The receiving the repositioning request can include receiving the repositioning request relative to the first work area marker and a target work area marker associated with a target work area, the target work area being associated with a target portion of the graphical data. The deriving can include deriving the updated work area associated with the first portion and the target portion. The deriving can include deriving the updated work area, associated with the portion and the target portion, and reflecting the adjustment request. The receiving can include receiving the repositioning request and the adjustment request originating from a single user action. The deriving can include deriving the updated work area reflecting the adjustment request having a parameter, the parameter reflecting the repositioning request. The deriving can include deriving the updated work including a copy of the portion of the graphical data. The receiving can include receiving the repositioning request, relative to a work area marker having a graphical icon, the icon including an identifying number, an identifying color, or a color based on the graphical data in proximity to the work area marker. The providing visually the updated marker can include displaying the icon. The receiving can include receiving a marker selection based on a keyboard shortcut, relative to the work area marker, indicating the adjustment request relates to the work area. The method can further include selectively displaying a visual indication of the work area relative to the graphical data based on input received via the marker.

Particular embodiments of the invention can be implemented to realize one or more of the following advantages. A user can more efficiently interact with (e.g., select) a work area. In addition, a user's focus can remain on the graphical data being edited while interacting with work areas, rather than having to interact with work areas using techniques that are visually separate from the graphical data.

In addition, programmatic focus problems in editors with multiple editing panels can be reduced or eliminated. For example, an image editor can have a main editing window and various sub panels within the window. Each sub panel can have the programmatic focus for the editor, such that user input will be received relative to the panel having focus. By providing a way to interact with work areas that is collocated with the graphical data, the complexity of programmatic focus and the number of misunderstandings regarding the area of an editor to which user input will apply can be decreased.

Additionally, interacting with a work area through a movable marker can provide for convenience and customization. For example, a marker can by default, be placed in an area where the user finds it inconvenient. By moving the marker not changing the portion of graphical data associated with a work area, the user can reposition the marker to a convenient place for work area interaction.

Furthermore, a user can easily (e.g., with a simple drag and drop mouse operation) unite disparate work areas. Uniting work areas can reduce the overall editing burden. For example, performing operations on one united work area can be more efficient than applying the same operations to each of several work areas individually.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 is a conceptual diagram showing an example overview of editing graphical data.

FIG. 2 is a system diagram showing interactions between a computer and components.

FIG. 3 is a block diagram showing an example interface for editing graphical data.

FIG. 4 is a flow diagram showing an example process for providing interaction with a graphical work area.

FIG. 5 is a flow diagram showing an example process for providing interaction with graphical work areas.

FIG. 6 is a block diagram depicting interfaces involved in work area interaction.

FIG. 7A is a block diagram depicting an interface for interacting with two work areas.

FIG. 7B is a block diagram depicting an interface including a combined work area. After the repositioning request depicted in

FIG. 8A is a block diagram depicting an interface for modifying an adjustment parameter.

FIG. 8B is a block diagram depicting an interface for modifying an adjustment parameter.

FIG. 8C is a block diagram depicting an interface for modifying an adjustment parameter.

FIG. 9 is a block diagram showing a relationship between a work area and a portion of graphical data.

FIG. 10 is a block diagram showing access to and representation of work area markers.

FIG. 11 is a block diagram showing an interface with different representations of work areas.

Like reference numbers and designations in the various drawings indicate like elements.

### DETAILED DESCRIPTION

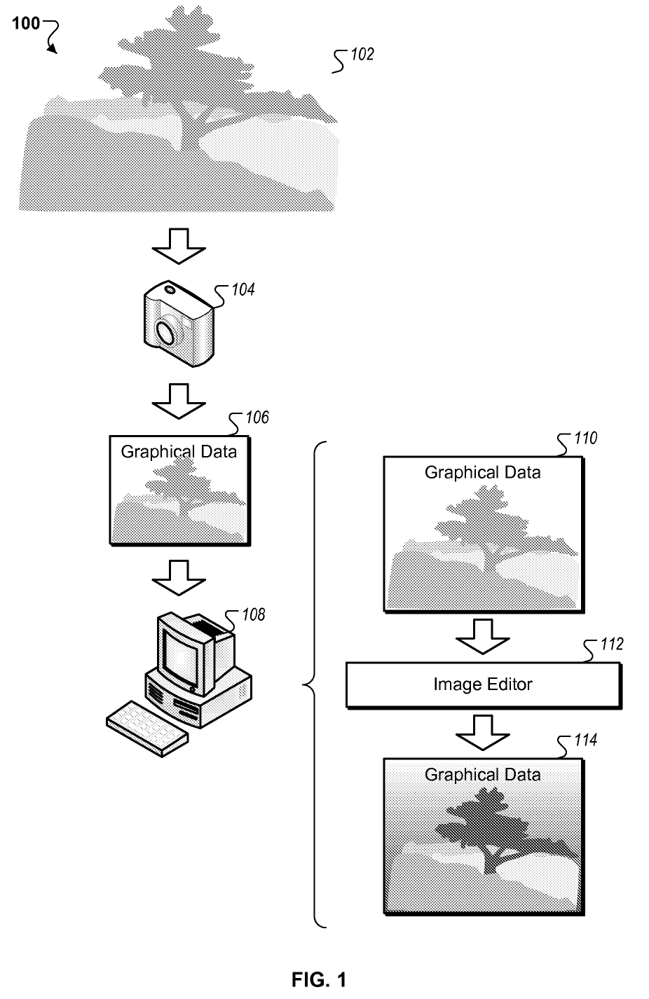

FIG. 1 is a conceptual diagram 100 showing an example overview of editing graphical data. In general, graphical data can include photographs, such as of a person, animal or landscape. Graphical data can also include non-photographic graphics, such as buttons, banners, or text, or a combination of photographic and non-photographic elements. Once produced, graphical data can be loaded onto a computer and edited. Editing graphical data can include adding elements (e.g., additional photographic material), deleting portions of data (e.g., cropping or replacing data with a solid color), or making other adjustments (e.g., changes to contrast level, brightening, or replacing color families).

As shown in FIG. 1, a scenic landscape 102 can be photographed with a camera 104. Photographs can depict many types of subject matter, such as the landscape 102, people, cars, or commercial products. Cameras, such as the camera 104, can include digital cameras. A digital camera, sometimes referred to as a “digicam,” can digitally take video, still photographs, or both using an electronic image sensor. Often thousands of images can be recorded on a single small memory device. Digital cameras are incorporated into many electronic devices ranging from personal digital assistants (PDAs) and mobile phones to vehicles.

Images are recorded as graphical data 106. The graphical data 106 can include data that represents the subject photographed. In addition, the data 106 can include metadata about the image, such as the date and time a photograph was taken. Often the graphical data 106 can be loaded on a computer 108 for viewing and editing. The computer 108 can include various mechanisms for receiving the graphical data 106 from the camera 104. For example, a Universal Serial Bus (USB) interface can provide a mechanism by which the graphical data 106 from the camera is transferred to the computer 108.

On the computer 108, graphical data 110 can be stored independently from the camera 104, such as on a hard drive. On the computer 108, the graphical data 110 can be stored as a file in an operating system, and subsequently viewed or edited. The graphical data 110 can be stored using a form of compression, such as lossless or lossy compression, that reduces the storage space required for the data 110 (e.g., as with files conforming to the standard established by the Joint Photographic Experts Group, JPEGs). The graphical data 110 can also be stored without compression.

On the computer 108, an image editor 112, can be a software application capable of loading the graphical data 110, displaying the data 110, allowing a user the alter the data 110, and then save the modified graphical data 114. For example, the original image 110, can be washed out because of non-optimal lighting when the photograph was taken by the camera 104. In the image editor 112, the adverse lighting effects can be reduced or eliminated, using various graphical tools. As a result, a corrected image 114, which is more pleasing to the eye, can be created.

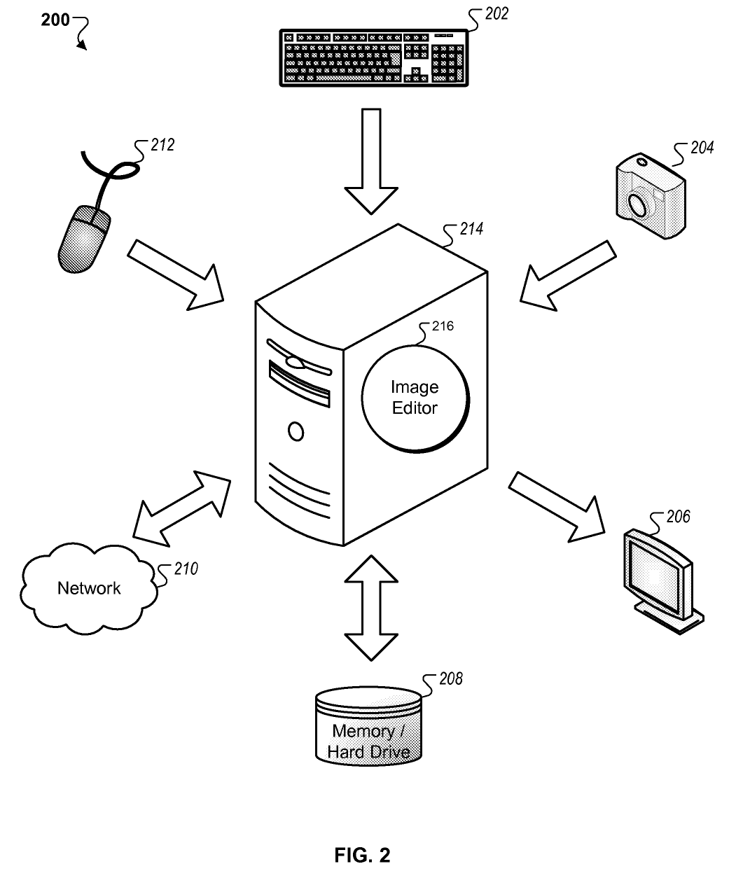

FIG. 2 is a system diagram 200 showing interactions between a computer and components. The computer 214 can enable software applications to run providing varied functionality. The computer 214 can be attached to various components allowing for input and output of data as well as interaction with the data.

As shown in FIG. 2, the computer 214 includes an image editor application 216. The editor 216 can run on the computer 214 and receive input from components or provide output to the components via the computer 214. The computer 214 can include memory and a processor (not shown) enabling applications, such as the editor 216, to execute.

When using the image editor 216, a user can control the editor using input devices, such as a mouse 212 or keyboard 202. Other devices through which a user can control operations of the editor 216 include touchscreens, light pens, trackballs and graphics tablets. Using the mouse 212, or other pointing device, a user can generally control the onscreen movements of a cursor. The cursor can be used to interact with a graphical user interface of the image editor 216. Using the keyboard 202, a user can input text into the editor 216 to be represented by the graphical data (e.g., a copyright notice or photographer attribution). The keyboard 202 can also be used to perform keyboard shortcuts, such as selecting a menu item or graphical tool. A shortcut can oftentimes achieve the same functionality as several steps using the mouse 212. For example, a keyboard shortcut can select the same command as clicking on a menu name to open the menu, and then clicking on an item within the menu.

The computer 214 can also be connected to a camera 204 using, for example, a USB or Institute of Electrical and Electronics Engineers (IEEE) standard 1394 (e.g., FireWire, i.Link, or Lynx) interface. Graphical data, such as photographs, can be transferred from storage in the camera 204 to the computer 214, and then opened and modified in the image editor 216.

The computer 214 can include a display 206 enabling a user to see or otherwise perceive (e.g., through touch as with a Braille terminal) output from the computer 214. The output shown on the display 206 can reflect input by the user, such as the movement of a cursor by a mouse 212, or modifications to graphical data requested by the user using the image editor 216.

The computer 214 can include access to electronic storage 208, such as memory or a hard drive. Many computers include a hard drive. However, a hard drive can also be external to the computer 214. In addition, the computer 214 can be connected to electronic storage 208 that is located remotely from the computer 214. In addition, when the image editor 216 loads an image from a hard drive, the image can be fully or partially loaded in volatile electronic storage 208 (e.g., random-access memory [RAM]). Often such electronic storage 208 provides improved performance to the image editor 216 during operations on the data which can then be save to non-volatile electronic storage 208.

The computer 214 can also include an interface to a network 210, such as the Internet or a corporate wide area network (WAN). The image editor 216, through the computer's interface with the network 210, can store graphical data remotely in electronic storage 208. The editor 216 can also request and receive updates or additions to its software. A user can share graphical data, using the image editor 216, with others on the network 210.

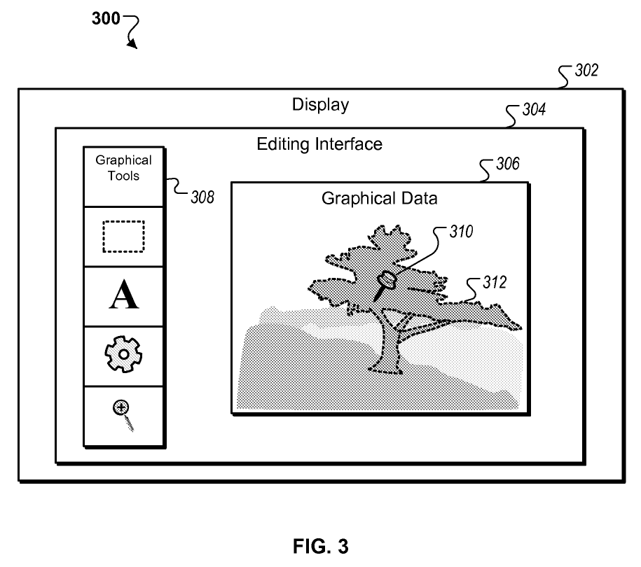

FIG. 3 is a block diagram 300 showing an example interface for editing graphical data. An image editor, such as the editor 216, in FIG. 2, can have a graphical user interface. A graphical user interface (GUI) allows a person to interact with a computer (e.g., desktop and laptop computers and hand-held devices). A GUI can offer graphical icons and other visual indications, enabling a user to see output (e.g., messages or responses) as well as representations of a user's input (e.g., movement of a cursor with a mouse).

As shown in FIG. 3, a display 302 can include an editing interface 304 for an image editor. The editing interface 304 can be window-based, allowing interaction with interfaces of more than one application. The editing interface 304 can also provide tools 308 that can be selected by a user and applied to graphical data 306.

The graphical tools 308 can include various kinds of operations. Some of the graphical tools 308 can specify types of modifications to graphical data. Other graphical tools 308 can provide for enhanced interaction with the graphical data 306 and other editing tools 308. For example, some graphical tools 308 may relate to selecting a portion of the graphical data 306 to which another of the graphical tools 308 will be applied. Graphical tools 308 can also provide for copying or deleting of portions of the graphical data 306.

Using one of the graphical tools 308, a user can select a work area 312 within a representation of the graphical data 306. The work area 312 can be shaped like a rectangle, ellipse, or many other regular and irregular shapes. The work area 312 can also include non-contiguous areas, separated by space not associated with the work area 312 (e.g., a work area 312 can include two circle shaped areas of the graphical data 306 that are non-overlapping). In FIG. 3, the work area 312 corresponds to a tree, and is shaped like the tree represented by the graphical data 306. In subsequent figures, work areas are represented with simple shapes (e.g., rectangles) for clarity though a work area shape need not be simple (e.g., a tree shape, as in FIG. 3).

The work area 312 can also be a selection of a portion of original graphical data 306. Changes applied to the work area 312, such as with the tools 308, can alter the actual graphical data 306.

Alternatively, the work area 312 can correspond to a portion of the graphical data 306, but include a copy of the graphical data 306, of a layer, corresponding to the work area 312. Changes applied to the work area 312 can alter the copy associated with the work area 312 rather than the actual graphical data 306. The altered copy can also be displayed in the interface 304 in the same location as the underlying original graphical data 306. As such, the adjustment applied can appear to have taken effect to the original graphical data 306, although the original graphical data 306 is preserved beneath the layer.

The work area 312 can be indicated visually relative to the graphical data 306. For example, the work area 312 can include a dashed border (i.e., marching ants). The indication, as depicted in FIG. 3 relative to the work area 312, can help a user to easily see what corresponds to the work area 312 out of the graphical data 306. Alternatively, a visual indication of the work area 312 may not be displayed. The user can be given the option of selectively displaying the indication.

Selecting the work area 312 can provide a way of limiting the effect of tools 308 applied to the graphical data 306. For example, given that work area 312 corresponds to the tree, a darkening adjustment can apply to just the work area 312, thus darkening the tree, rather than the remainder of the graphical data 306.

A marker 310 can facilitate interaction with the work area 312. The marker 310 can include a visual representation, such as a representation of a pin. Clicking on the marker 310 with a mouse cursor can select the work area 312 as the target of a graphical operation by one of the tools 308. Clicking on the marker 310 can also provide access to a context menu, and can include options pertaining to the work area 312. Single clicking and doubling clicking on the marker 310 can have different results and allow additional interactivity with the work area 312.

The marker 310 can also be moved relative to the graphical data 306 and work area 312. Moving the marker 310 by dragging and dropping (e.g., a down click on a mouse button, followed by movement of the mouse, and a subsequent release of the button, or a “mouse up”) can allow the marker 310 to be repositioned. Repositioning the marker 310 can change the marker 310 location without changing the location of the work area 312. Moving the marker 310 can change a parameter associated with one of the tools 308 applied to the work area 312. For example, moving the marker 310 in one direction can intensify or de-intensify the effect of one the tools 308, and can provide fine-grained adjustment of tools effects.

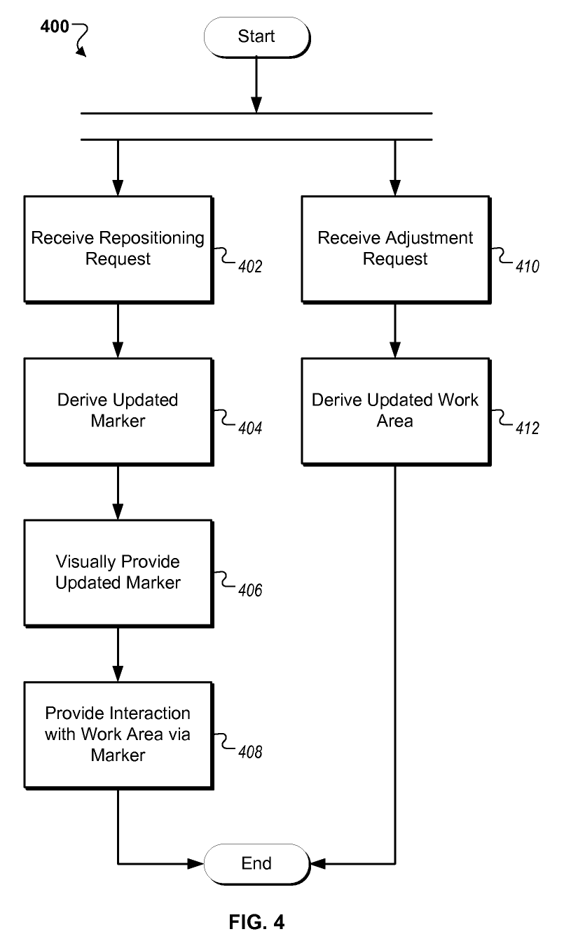

FIG. 4 is a flow diagram showing an example process 400 for providing interaction with a graphical work area. The process 400 provides that certain operations can be parallel or asynchronous to other operations. Through the process 400, a work area can be graphically adjusted and a marker, providing interaction with the area, repositioned.

The process 400, at 402, receives a repositioning request relative to a marker. The marker is associated with a work area. The repositioning request can result from a mouse drag-and-drop operation. In addition, the request can result from input on a keyboard, such as a user pressing the arrow keys when the marker is selected. The request can also be programmatic and not originate with the user or an input device. For example, process 400 can receive the repositioning request from an image editing application. A programmatic request can occur when the application needs to move the marker, such as to allow a user to see the marker when it has been obscured by something on a user interface.

The process 400, at 404, derives an updated marker. Deriving the updated marker relates to the repositioning request. For example, deriving the updated marker can include determining where on the screen to display the marker given the reposition request. The process 400 can take into account considerations such as limits relating to the user interface when deriving the updated marker. For example, a user may attempt to drag a marker out of the bounds of displayed graphical data. Rather than honoring the request, the process 400 can determine that the marker should be placed within the bounds but as close to the requested repositioning target as possible. The process 400 can also decide that the updated marker should reflect visual changes from the marker prior to the receipt of the request. For example, after repositioning, the marker can be colored differently.

The process 400, at 406, visually provides the updated marker, e.g., through a user interface. The updated marker being visually provided can allow a user to see the results of the request on the process 400 and that the request had an effect. Visually providing can convey information from the process 400 to the user such as indicated by a color change. For example, the repositioning request, received at 402, can correspond to modifying a parameter associated with a graphical adjustment applied to graphical data. Process 400 can derive an updated marker, at 404, colored to show the level of change resulting from the request. At 406, the process 400 visually providing the updated marker can help a user to see if the parameter modification is appropriate to accomplish the desired change.

At 408, the process 400 provides interaction with the work area via the marker. For example, the process 400 can receive another repositioning request relative to the updated marker, starting the process 400 again, at 402.

The process 400, at 410, receives an adjustment request relating to a work area. For example, the adjustment request can be brightening or changing the hue of graphical data associated with the work area. The adjustment can include a single-graphical-aspect operation, such as changing the lightness of the graphical data. The adjustment can also include a set of operations, changing multiple graphical aspects in a single adjustment.

Given the adjustment request, the process 400, at 412, derives an updated work area. Deriving the updated work area can include applying the operations indicated by the adjustment request to the work area. Deriving can also include selectively applying graphical operations even when requested, such as applying or not applying operations available based on the graphical context (e.g., in compatibility with other adjustments previously applied). Deriving can involve modifying original graphical data indicated by the work area, or, alternatively, modifying a copy of the indicated graphical data.

If the process 400, at 412, has derived an updated work area, the process 400, at 408, can provide continued interaction with the new work area through the updated marker.

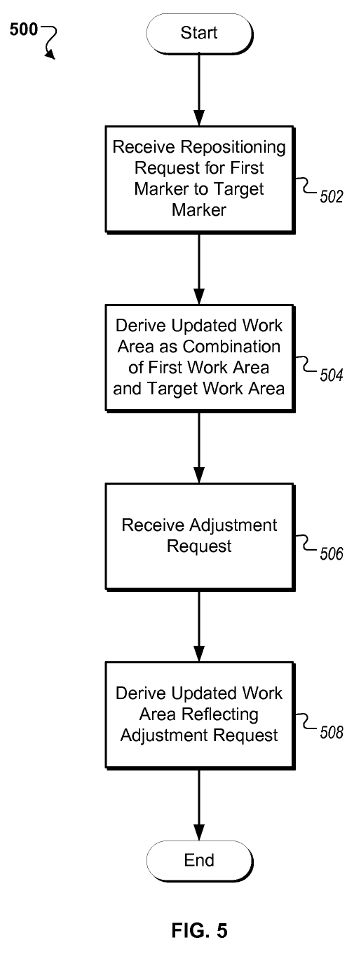

FIG. 5 is a flow diagram showing an example process 500 for providing interaction with graphical work areas. Through the process 500, two work areas can be combined into a single work area using the markers associated with each area, and a graphical adjustment can be applied to the combined work area.

The process 500, at 502, receives a repositioning request relative to a first marker and a target marker. The repositioning request, relative to the two markers, can include a drag-and-drop operation of the first marker onto the target marker. The request can, alternatively, include selecting the first marker and the target marker simultaneously (e.g., holding down the Ctrl or Command button while clicking on each), and requesting the associated work areas be combined (e.g., through a menu option or context menu).

Furthermore, the request can include receiving an indication the first marker is to be merged, and then an indication the target marker is the target of the merger. For example, a double-click, using a mouse, on the first marker can place the marker in a merge state. A subsequent single-click, using the mouse, on the target marker can complete the repositioning request, having identified two markers and the intent to merge their associated work areas. Alternatively, the first marker can be placed in a merge state through a keyboard shortcut, and the target marker indicated to be the merger target through another keyboard shortcut.

The process 500, at 504, derives an updated work area representing the first work area and the target work area. The updated work area can be a “union” combination of the work areas, such that all the first work area and all the target work area is included in the updated work area. The updated work area can also represent another type of operation relative to the two work areas, such as an exclusive OR (XOR) (i.e., area included in either, but not both, work areas is included in the resulting area) or an intersection (i.e., overlapping area; only area include in both work areas is included in the resulting area).

The process 500, at 506, receives an adjustment request relative to the combined work areas. For example, the adjustment request can be to brighten or change the hue of the work area. The adjustment can include a single-graphical-aspect operation, such as changing the lightness of the graphical data. The adjustment can also include a set of operations, changing multiple graphical aspects in a single adjustment (e.g., changing lightness and hue).

The process 500, at 508, derives an updated work area reflecting the adjustment request. The adjustment can be applied equally to all the graphical data, whether original or a copy, associated with the updated work area. Alternatively, the adjustment can be applied disparately to the portion of the updated work area originating with the first work area and the portion originating with the target work area. Furthermore, the adjustment can be applied disparately depending on whether a portion of the updated work area was associated with one or both of the originating work areas.

In addition, the process 500, at 508, can derive an updated work area reflecting an adjustment command which was only associated with one of the originating work areas prior to the merger. On being combined, at 504, the process 500 can receive an adjustment request from, e.g., the first work area, to then apply, as part of deriving, at 508, to the updated work area.

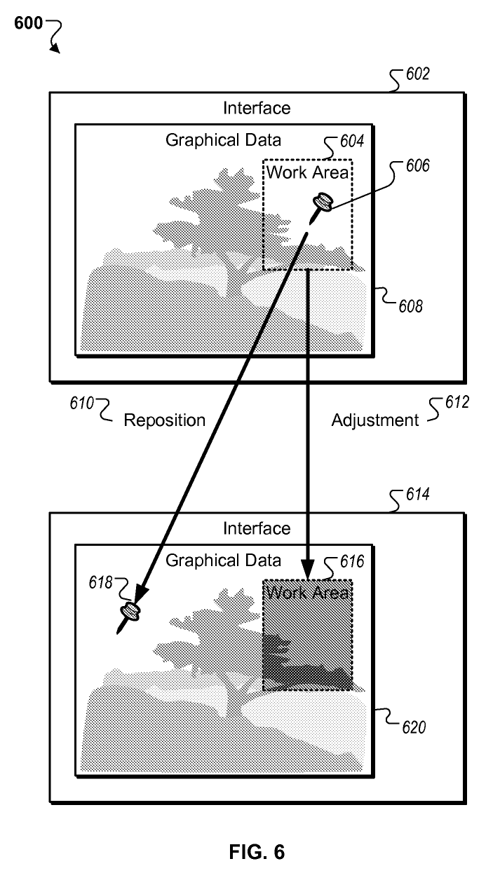

FIG. 6 is a block diagram 600 depicting interfaces involved in work area interaction. The diagram 600 can, e.g., represent the operation of the process 400, shown in FIG. 4.

As shown in FIG. 6, diagram 600 shows the effect of receiving a repositioning request and adjustment request through an interface 602. The interface 602 includes a visual representation of graphical data 608. The interface 602 can be a GUI for an image editor. The graphical data 608 can be displayed by the image editor, e.g., in a window within the interface 602.

Part of the graphical data 608 is associated with a work area 604. The work area 604 includes a work area marker 606. The work area 604 is shown as a rectangle but need not be rectangular, as shown in FIG. 3. The work area marker 606 is shown as a pin-like icon but can, instead, be many other icons (e.g., an “X,” or a circle).

The work area 604 can be selected explicitly by the user or as part of another operation (e.g., a painting operation). The portion of the graphical data 608 associated with the work area 604 can be intelligently selected based on a graphical tool used. For example, a work area associated with the sky portion of graphical data 608 can be selected by using a sky tool. The image editor can, based on the graphical characteristics of the graphical data, 608, determine which portion of the graphical data 608 is sky based a location indicated on the graphical data by the user.

The work area 604 can be selected by a user to indicate an area to which the user wants to apply graphical adjustments. For example, a user can select a portion of graphical data needing a correction, such as lightening, relative to the rest of the graphical data.

The interface 614 shows a subsequent view of the interface 602, after receipt of a reposition request and adjustment request, to visually depict the resulting effects relative to graphical data 620.

The arrow 610 indicates an exemplary change resulting from a reposition request. The work area marker 606 can be repositioned, relative to the work area 604 and graphical data 608, to a new location. Updated work area marker 618 represents the marker in the new location. When the marker is repositioned, the portion of the graphical data associated with the work area 604 remains unchanged. Repositioning of the updated marker 618 can allow a user to place the marker 618 in a location, e.g., for improved convenience. For example, images can be so large that they cannot be entirely viewed without scrolling. A work area 604 can be located in a portion of graphical data 608 not currently visible. To provide convenient interaction with the work area 604, an image editor can allow the user to reposition the work area marker 606.

The arrow 612 indicates an exemplary change resulting from an adjustment request. A user can apply a graphical operation to work area 604 (e.g., a fill tool). As a result, an updated work area 616 can be produced reflecting the effect of the graphical tool. The updated work area 616 can represent modifications directing to the graphical data 620. Alternatively, the updated work area 616 can represent modifications to a copy of a portion of the graphical data 620, leaving the graphical data 620 unchanged by the adjustment request. Even when applied to a copy, however, the adjustment effects can be displayed in interface 614 over the graphical data 620, as though the graphical data 620 itself was modified.

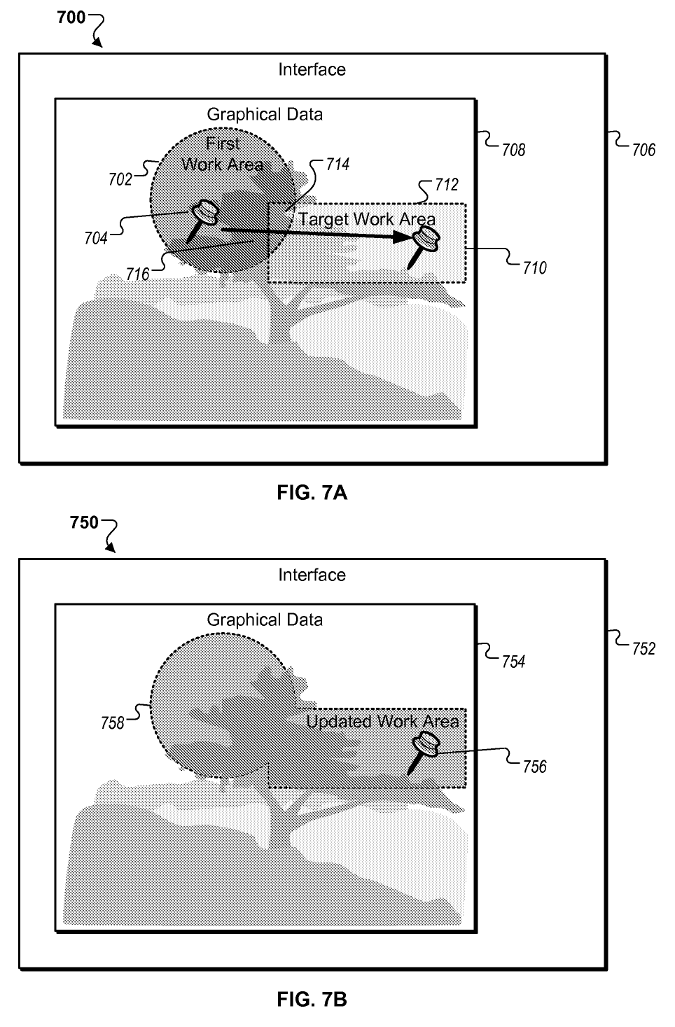

FIG. 7A is a block diagram 700 depicting an interface 706 for interacting with two work areas. Within an image editor, having an interface 706 for editing graphical data 708, multiple work areas can be associated with disparate portions of the graphical data 708. The work areas can have markers for interacting with the work areas.

As shown in FIG. 7A, a first work area 702 is associated with a portion of graphical data 708. The first work area 702 includes a work area marker 704, allowing interaction with the area 702. In addition, a graphical adjustment has been applied to the first work area 702, as shown by the pattern.

Block diagram 700 also shows a target work area 712, associated with a portion of graphical data 708. The target work area 712 includes a work area marker 710, allowing interaction with the area 712. In addition, a graphical adjustment has been applied to the target work area 712, as shown by the pattern, that is distinct from the adjustment applied to the first work area 702. The work areas intersect in an area 714 in which both adjustments are applied to graphical data 708.

The first work area marker 704 can be repositioned to target work area marker 710, as shown with the arrow 716. The repositioning request can indicated that the work areas should be combined, such as with a union operation.

FIG. 7B is a block diagram 750 depicting an interface 752 including a combined work area. After the repositioning request depicted in FIG. 7A is received, an updated work area 758 relating to both source work areas can be derived. As shown in diagram 750, the adjustments associated with both source work areas in FIG. 7A, can be applied to the updated work area 758. Applying both adjustments can result in modification of the graphical data 754 associated with the updated work area 758. After merging the source work areas, one work area marker 756 remains, allowing interaction with the updated work area 758.

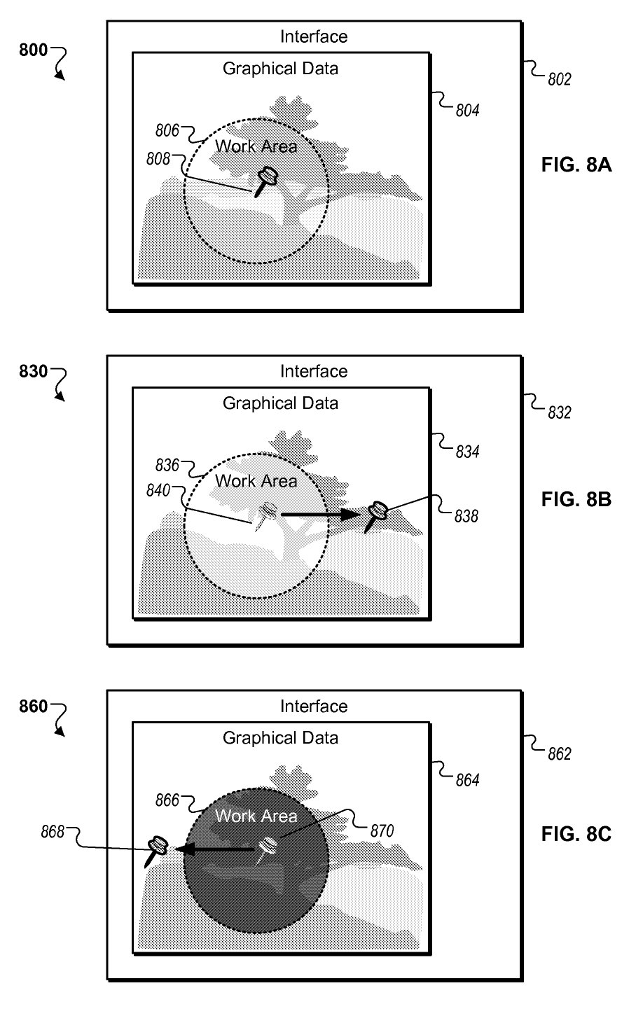

FIG. 8A is a block diagram 800 depicting an interface 802 for modifying an adjustment parameter. A work area 806 can indicate a portion of graphical data 804 to be adjusted with a graphical operation. A work area marker 808 can provide a way of adjusting a parameter of the graphical operation, such as a level of a brightening operation. Relative to the work area 806, the work area marker 808 is in a starting position. In the starting position, the adjustment parameter can be set to a default value.

Moving a work area marker, such as marker 808, can alter a single adjustment parameter. For example, moving the marker to the right can increase the parameter, and moving the marker to the left can decrease the parameter. Also, instead of horizontal movement, moving the marker up or down can increase or decrease the parameter.

Alternatively, moving the work area marker can affect multiple adjustment parameters of an operation. For example, a color adjustment operation can have two parameters: a red-green balance and blue level. Moving the marker up from a starting position can increase red level and decrease green level resulting from the operation. Moving the marker down from a starting position can increase the green level and decrease the red level resulting from the operation. Moving the marker left and right can increase or decrease, respectively, the blue level.

Moreover, movement of the work area marker can be associated with parameters of multiple operations. For example, two operations, for which simultaneous adjustment is advantageous, are brightness and contrast. Left and right movement can increase or decrease, respectively, the brightness, while up and down movement can increase or decrease, respectively, contrast.

The work area marker can also be selectively associated with one or more operations. For example, a user can select which operations to associate with a marker and then subsequently associate different operations with the same marker.

FIG. 8B is a block diagram 830 depicting an interface 832 for modifying an adjustment parameter. A work area 836 shows an exemplary effect of moving a work area marker 838 from a starting position 840 to the right: a portion of graphical data 834 associated with the work area 836 is modified by changing the brightness level of the adjustment. In the example, the work area 836 is now brighter than the work area 806, shown in FIG. 8A.

FIG. 8C is a block diagram 860 depicting an interface 862 for modifying an adjustment parameter. A work area 866 shows an exemplary effect of moving a work area marker 868 from a starting position 870 to the left: a portion of graphical data 864 associated with the work area 866 is modified by changing the brightness level of the adjustment. In the example, the work area 866 is now darker than the work area 806, shown in FIG. 8A.

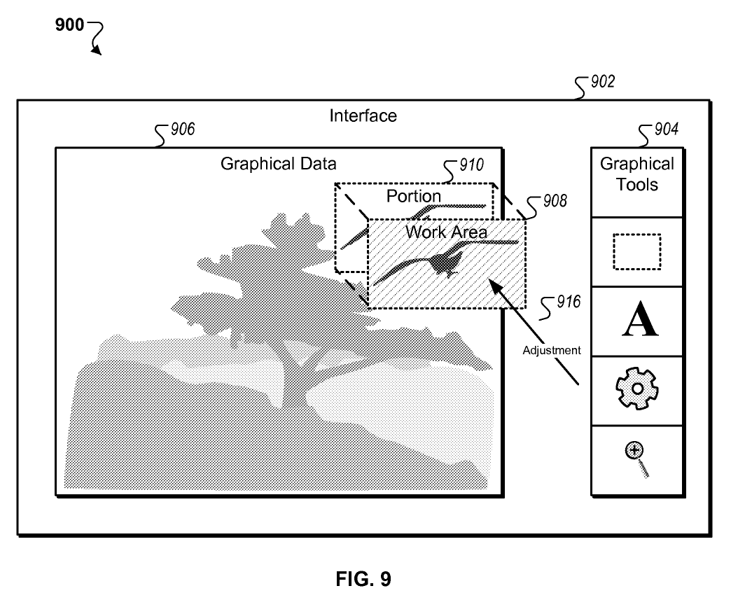

FIG. 9 is a block diagram 900 showing a relationship between a work area 908 and a portion 910 of graphical data 906. The interface 902, such as for an image editor, includes graphical data 906 and a set of graphical tools 904. A user can select a graphical tool from the set 904, and apply 916 the tool to the graphical data 906.

When applying 916 the tool, a copy of a portion 910 of graphical data 906 can be created in response. The work area 908 can include the copy of the portion 910 of graphical data 906. When an adjustment is applied 916 to the work area 908, the graphical data copy associated with the work area 908 can be modified rather than the source data 910. As such, the work area 908 can be deleted, leaving the graphical data 906 unchanged with respect to the work area 908. In addition, modifications affecting the work area 908 can be later adjusted, also without changing the original graphical data 906.

As shown in FIG. 9, the work area 908 is shown overlaid on the portion 910 of the graphical data 906. Overlaying the work area 908 on the portion 910 can provide the appearance that the graphical data 906 itself has been modified. Thus, a user can be unaware that the work area 908 includes a copy of the portion 910 of graphical data 906 that has been modified rather than the original graphical data 906. Not needing to be aware can help to prevent distractions for users desiring a simplified editing experience. At the same time, users can benefit from non-destructive editing capability.

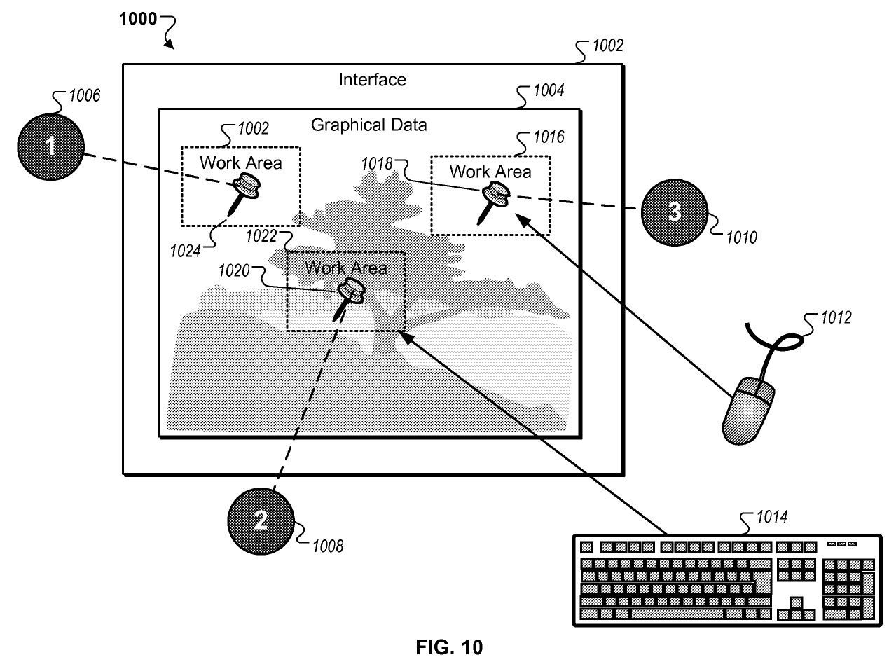

FIG. 10 is a block diagram 1000 showing access to and representation of work area markers. Interface 1002 includes graphic data 1004 having three work areas, 1002, 1016 and 1022. The work areas 1002, 1016 and 1022 include work area markers 1024, 1018, and 1020, respectively. In situations with multiple work areas, as shown in FIG. 10, work area markers enhance the ability of a user to interact with the work areas without having to divert attention from the graphical data.

In addition, work area markers, such as marker 1018, can be selected using a mouse 1012 (e.g., placing a mouse cursor on top of the marker 1018 and clicking). A worker area marker 1020 can also be selected by a keyboard 1014 shortcut. For example, Ctrl-Shift-2 can selected the marker 1020, designated with by the number 2.

The markers 1024, 1018 and 1020 can include a graphical icon to provide distinction among markers and from the underlying graphical data 1004. For example, the markers 1024, 1018 and 1020 can include icons including numbers 1006, 1010 and 1008, respectively. The numbers associated with the icons 1006, 1010 and 1008 can correspond to the keyboard shortcuts. Each time a marker is placed on the graphical data 1004, the next higher number can be used for the icon. The icons 1006, 1010 and 1008 can instead include, e.g., letters or Roman numerals.

The icons 1006, 1010 and 1008 can include differing colors so that the markers 1024, 1018 and 1020 can be distinguished. For example, each time a marker is placed on the graphical data 1004, the next color from a sequence of colors can be used for the icon.

Furthermore, the icons 1006, 1010 and 1008 can be colored based on the portion of graphical data 1004 over which the marker is placed. For example, on a red area of graphical data 1004, a contrasting green color can be selected for the marker icon, which can allow a user to more easily see the marker.

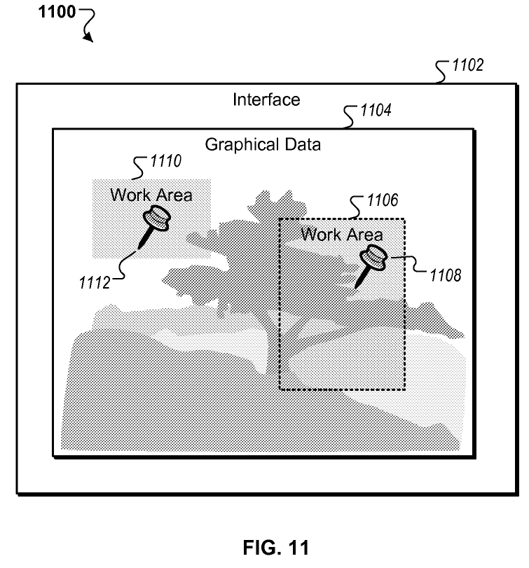

FIG. 11 is a block diagram 1100 showing an interface 1102 with different representations of work areas. Markers can facilitate interaction with work areas. The graphical data of an image being edited can include multiple work areas. The region associated with a work area can be visually distinguished from the graphical data as a whole. Visual distinctions can include, e.g., a dashed or marquee border (i.e., marching ants), or a shaded representation of the associated graphical data.

When multiple work areas 1110 and 1106 exist, as shown in FIG. 11, markers can be particularly helpful. For example, a user can use a marker 1112 to select whether a work area is visually distinguished or not. All work areas can be distinguished by default. A marker's context menu (e.g., raised by right clicking on the marker) can provide an option of hiding (e.g., the work area 1110) or showing (e.g., the work area 1106) the work area's border. Thus, using this option, a user can determine whether all, some or none of the work area borders are displayed.

When multiple work areas exist, one or more of the work areas can be active for editing at a given time. In some implementations, an active work area can be distinguished, e.g., through use of a marquee border or a marquee border of a distinct color. For example, all the work areas, except one, which is active, can be distinguished using a grey border—the active work area using a white border. Selecting a marker can activate the associated work area for editing, thus, displaying the visual distinction.

As shown in FIG. 11, the graphical data 1104 includes a work area 1106, with an associated work area marker 1108. The work area 1106 can be distinguished using a marquee border (i.e., marching ants). Alternatively, a work area 1110 can be hidden, without a visible border indicating the area's 1110 location. An option in a context menu associated with the work area marker 1112 can allow the work area 1110 border to be selectively displayed.

Embodiments of the subject matter and all of the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, or a combination of one or more of them. Computer program instructions, which are thus encoded (e.g., as physically stored binary data), are a tangible article of manufacture that defines structural and functional interrelationships between the computer program and other components of a data processing apparatus, which permits the functionality to be realized.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. Moreover, when functionality of one or more computer program products is realized through the data processing apparatus, the instructions transform physical aspects of the apparatus into a different state. For example, flip-flops, latches, transistor gates or capacitors included in a memory device can be transformed by the operation of the instructions to a different electronic state or level of electrical or magnetic charge.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

1. A method, implemented by a computer configured to provide graphical work areas, the method comprising:
presenting graphical data, a work area, and a work area marker, wherein the work area is selectable via the work area marker, the work area indicates a portion of the graphical data to be adjusted with a graphical operation when the work area is currently selected, and the work area remains unchanged when the work area is not currently selected;
receiving an adjustment request via the work area marker when the work area is currently selected;
updating the work area marker in accordance with the adjustment request; and
changing graphical data for the portion indicated by the work area in accordance with the graphical operation and the adjustment request.

2. The method of claim 1, comprising associating a different graphical operation with the work area marker based on user input.

3. (canceled)

4. The method of claim 1, wherein the adjustment request alters a single adjustment parameter for the graphical operation.

5. The method of claim 1, wherein the work area marker is associated with parameters of multiple graphical operations.

6. The method of claim 1, wherein changing graphical data for the portion comprises;
creating a copy of graphical data in the portion indicated by the work area; and
modifying the copy of the graphical data.

7. The method of claim 1, wherein
the work area marker is a graphical icon, the graphical icon including an identifying number or an identifying color.

8. The method of claim 7, wherein the graphical icon includes a color based on graphical data in proximity to the work area marker.

9. The method of claim 1, further comprising:
selectively displaying a visual indication of the work area relative to the graphical data based on input received via the work area marker.

10. A computer program product, tangibly encoded on a computer-readable medium, operable to cause data processing apparatus to perform operations comprising:
presenting graphical data, a work area, and a work area marker, wherein the work area is selectable via the work area marker, the work area indicates a portion of the graphical data to be adjusted with a graphical operation when the work area is currently selected, and the work area remains unchanged when the work area is not currently selected;
receiving an adjustment request via the work area marker when the work area is currently selected;
updating the work area marker in accordance with the adjustment request; and
changing graphical data for the portion indicated by the work area in accordance with the graphical operation and the adjustment request.

11. The computer program product of claim 10, wherein the operations comprise associating a different graphical operation with the work area marker based on user input.

12. (canceled)

13. The computer program product of claim 10, wherein the adjustment request alters a single adjustment parameter for the graphical operation.

14. The computer program product of claim 10, wherein the work area marker is associated with parameters of multiple graphical operations.

15. The computer program product of claim 10, wherein changing graphical data for the portion comprises:
creating a copy of graphical data in the portion indicated by the work area; and modifying the copy of the graphical data.

16. The computer program product of claim 10, wherein
the work area marker is a graphical icon, the graphical icon including an identifying number or an identifying color.

17. The computer program product of claim 16, wherein the graphical icon includes a color based on graphical data in proximity to the work area marker.

18. The computer program product of claim 10, the operations further comprising:
selectively displaying a visual indication of the work area relative to the graphical data based on input received via the work area marker.

19. A system comprising:
a user interface device; and
one or more computers operable to interact with the user interface device and to perform operations comprising:
presenting graphical data, a work area, and a work area marker, wherein the work area is selectable via the work area marker, the work area indicates a portion of the graphical data to be adjusted with a graphical operation when the work area is currently selected, and the work area remains unchanged when the work area is not currently selected;
receiving an adjustment request via the work area marker when the work area is currently selected;
updating the work area marker in accordance with the adjustment request; and
changing graphical data for the portion indicated by the work area in accordance with the graphical operation and the adjustment request.

20. The system of claim 19, wherein the operations comprise associating a different graphical operation with the work area marker based on user input.

21. (canceled)

22. The system of claim 19, wherein the adjustment request alters a single adjustment parameter for the graphical operation.

23. The system of claim 19, wherein the work area marker is associated with parameters of multiple graphical operations.

24. The system of claim 19, wherein changing graphical data for the portion comprises:
creating a copy of graphical data in the portion indicated by the work area; and modifying the copy of the graphical data.

25. The system of claim 19, wherein
the work area marker is a graphical icon, the graphical icon including an identifying number or an identifying color.

26. The system of claim 25, wherein the graphical icon includes a color based on graphical data in proximity to the work area marker.

27. The system of claim 19, the operations further comprising:
selectively displaying a visual indication of the work area relative to the graphical data based on input received via the work area marker.
